(19) United States
(12) Patent Application Publication
(10) Pub. No.: US 2024/0322643 A1
(43) Pub. Date: Sep. 26, 2024

(54) Cable Cover with Cable Guide

(71) Applicant: KSB SE & Co. KGaA, Frankenthal (DE)

(72) Inventor: Axel SCHUNK, Frankenthal (DE)

(21) Appl. No.: 18/578,810

(22) PCT Filed: Jul. 8, 2022
(86) PCT No.: PCT/EP2022/069129

§ 371 Date: Jan. 12, 2024

(30) Foreign Application Priority Data
Jul. 15, 2021 (DE) 10 2021 118 376.6

(51) Int. Cl. H02K 5/22; H02K 11/00

(52) U.S. Cl. CPC H02K 5/225; H02K 11/0094

(57) ABSTRACT

An electric motor includes a drive module. The drive module has a connection chamber and a cable connection assembly. The connection chamber is closed with a cover. The cover projects beyond the cable connection assembly.

### CROSS REFERENCE TO RELATED APPLICATION

This application claims priority under 35 U.S.C. § 119 from German Patent Application No. 102021118376.6, filed Jul. 15, 2021, the entire disclosure of which is herein expressly incorporated by reference.

### BACKGROUND

The disclosure relates to an electric motor having a drive module, which has a connection chamber and a cable connection assembly, wherein the connection chamber is closed with a cover.

The electric motor is an electromechanical drive that converts electrical energy into mechanical energy. Depending on the form in which the electrical energy is available, direct current motors, alternating current motors, or three-phase motors are used. Generally, the electrical energy is converted into a rotational movement. This rotational movement can for example drive shafts with impellers of centrifugal pumps.

The speed of the centrifugal pump and accordingly the torque of the impeller shaft is controlled and regulated via a drive module at the electric motor. Such a drive module is positioned close to the electric motor and comprises at least one frequency converter and a speed-regulating device. Such a drive module can also comprise further control or regulation devices.

A frequency converter is an electronic device that generates a voltage with changed amplitude and frequency from a three-phase or alternating current. This is used to improve the startup behavior and speed behavior of three-phase motors. Frequency converters also regulate the speeds of single-phase asynchronous motors, which are used to drive centrifugal pumps.

The drive module is connected to at least one current cable via a screwed cable gland. Furthermore, bus cables and/or sensor lines can also be connected to the drive module via screwed cable glands. These screwed cable glands must be oriented downward, i.e., at an angle of less than 90° to the perpendicular, i.e., to the direction of gravity, so that no moisture can get into the drive module via the cables.

The laterally arranged and downwardly oriented screwed cable glands usually lead to particularly large structural dimensions of drive modules. Furthermore, the screwed cable glands are often unprotected from environmental influences and dirt.

### SUMMARY

One object of the disclosure is to provide an electric motor including a drive module with a cover. The cover is intended to protect the screwed cable glands of the drive module. Furthermore, the cover should prevent the ingress of moisture and dirt. Furthermore, the cover is intended to have a compact design. The connection of cables should be facilitated by the structure of the cover. The cover should be simple and cost-effective to realize.

This and other objects are achieved according to the disclosure by an electric motor having a drive module. Preferred variants can be found in the description and the drawings.

According to the disclosure, a cover projects beyond a cable connection assembly of a drive module that is attached to an electric motor. The drive module comprises at least one speed regulation means and/or a frequency converter, which are arranged in an electronics chamber, in order to control and/or regulate the electric motor as the drive of a centrifugal pump. The necessary wiring is preferably arranged in a connection chamber adjacent to the electronics chamber. Furthermore, further circuit boards having additional control and/or regulation tasks can be provided.

Preferably, the cable connection assembly comprises multiple screwed cable glands, via which, for example, the circuit boards are supplied in a wired manner with electrical energy and the necessary control and/or regulation signals. The screwed cable glands seal the cable entry and thus avoid the ingress of moisture into the connection chamber. Screwed cable glands are leakproof in the long term only if it is not possible for water to accumulate thereon or for water to flow along the cable and then remain on the seal. The screwed cable glands are designed without sharp edges and seal the cable entry with particularly yielding material.

According to the disclosure, the cover is screwed onto the drive module. In an alternative variant, however, the cover can also be locked with suitable clips and/or adhesively bonded. Advantageously, the cover at least partially covers the cable connection assembly and thus protects the cable connection assembly from environmental influences and dirt.

In a particularly advantageous variant, the cover encloses the entire cable connection assembly. The protection from environmental influences and dirt is thus particularly pronounced. In common practice, the screwed cable glands are usually arranged in a sloping form, unprotected, on the side of a drive module. The horizontal and covered arrangement of the screwed cable glands according to the disclosure is characterized by particularly compact dimensions of the drive module. Ideally, the formation of the cover contributes to a small structural height of the drive module.

Advantageously, the connection chamber is spatially separated from the cable connection assembly by means of an element. Preferably, the element is a sealing ridge on which the screwed cable glands are arranged stably and which has corresponding cable tubes extending from the screwed cable glands into the connection chamber. The sealing ridge has a seal element, which bears sealingly against the cover, on each of its outer sides.

According to the disclosure, the cover has at least one opening for feeding the cables to the cable connection assembly. This opening is designed such that the cables provided have sufficient space for cable entry and at the same time little space remains for the ingress of dirt.

Ideally, the cover is preferably formed as a single piece. This is particularly advantageous, since a reduction in the number of parts, in particular for the drive module, means lower production costs and less assembly effort. In an alternative variant, the cover can be formed in multiple parts.

According to the disclosure, the drive module has a guide element, which orients a connection portion of a cable of the cable connection assembly downward. The connection portion is formed by the few centimeters of a cable end toward the screwed cable gland. The downward orientation of the connection portion of the cable, in particular in the direction of gravity, prevents moisture being fed to the screwed cable gland. Droplets of liquid running along the cable drip from the lowest point of the cable, before the connection portion. The screwed cable gland, which otherwise usually slopes and takes up space, can have a space-saving and horizontal design thanks to the cover according to the disclosure.

In an alternative variant of the disclosure, the guide element is in the form of a fastening clip, which orients the connection cable(s) downward in a connection portion and in the process fixes it/them firmly.

Preferably, the guide element orients the cable at an angle between a horizontal of the cable feed and a straight line between a contact point of the guide element on the cable and a highest point of the cable directly at the exit point from a fixing element. The guide element orients the cable downward at an angle between the horizontal and the described straight line of more than 5°, preferably more than 10°, in particular more than 15°, and/or less than 80°, preferably less than 70°, in particular less than 60°.

According to the disclosure, a connection portion of a cable fed to the drive module is oriented such that the connection portion is always positioned lower than the screwed cable gland. Advantageously, this ensures that no moisture adhering to the cable can be fed to the screwed cable gland.

In an alternative variant of the disclosure, the guide element is in the form of an elastic element, which is installed in front of the cover and is spring-loaded such that a connection portion of a fed cable is always oriented downward.

Ideally, the guide element does not have sharp edges. Furthermore, the guide element reacts elastically, so that an upward application of force of the cable can be yielded to elastically and does not result in breakage of the guide element.

According to the disclosure, the cover has at least one seal element, so that the connection chamber is closed absolutely sealingly. This is particularly advantageous because the connection chamber and the sensitive electronics arranged therein are protected from moisture and dirt. Precisely in the use case of a centrifugal pump, the environmental influences prevailing at the site of installation can have an unfavorable effect on the functioning and operating duration of the electronics of the drive module. The cover according to the disclosure is an effective protective device for this.

The cover according to the disclosure is preferably manufactured from a plastic, in particular a polycarbonate. In manufacturing by means of injection-molding and/or additive methods, plastics allow particular designs of the cover while at the same time keeping production costs favorable.

Further features and advantages of the disclosure can be found in the description of exemplary embodiments with reference to the drawings, and in the drawings themselves. In the figures:

### BRIEF DESCRIPTION OF THE DRAWINGS

FIG. 1 shows a perspective view of an electric motor having a drive module,

FIG. 2 shows a perspective diagram of the drive module, and

FIG. 3 shows a sectional diagram of an electric motor with the drive module.

### DETAILED DESCRIPTION

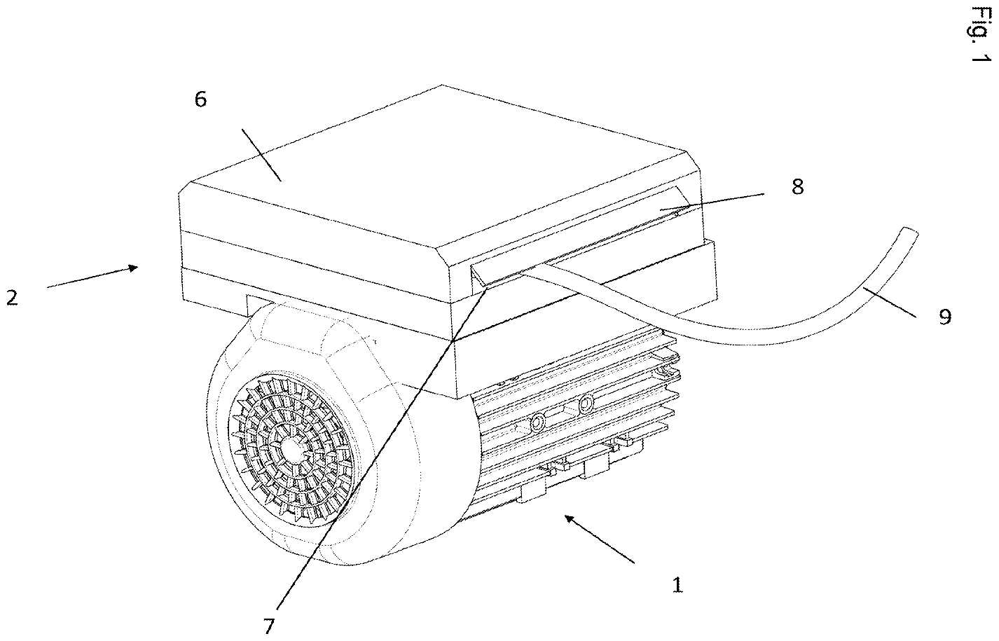

FIG. 1 shows an electric motor 1 having a drive module 2. The drive module 2 is arranged on the electric motor 1 and sits flush on the cooling fins. A current-carrying cable 9 is connected by way of example to the drive module 2, wherein the current-carrying cable 9 is fed via an opening 7 in the cover 6 into the drive module 2 to the covered cable connection assembly 5 (not shown). A guide element 8 defines a cable course for the cable 9, which cable course is oriented downward in the direction of gravity and thus prevents the ingress of moisture.

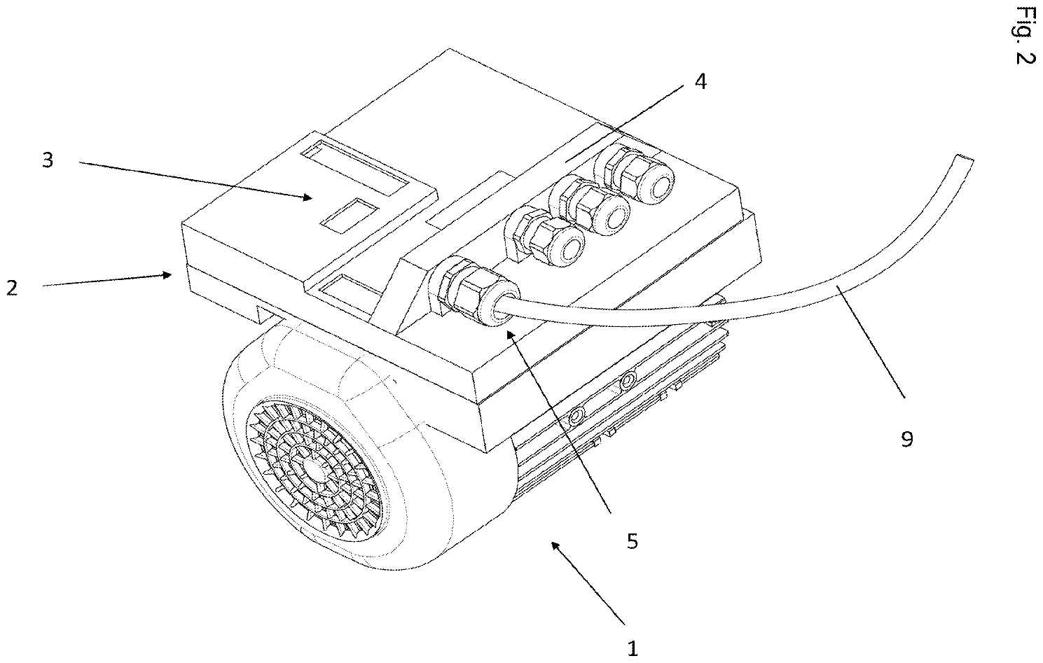

FIG. 2 shows a perspective diagram of the drive module 2, which is shown without the cover 6. The drive module 2 is arranged on the electric motor 1. The connection chamber 3 is spatially separated from the four cable connection assemblies 5 shown by an element 4.

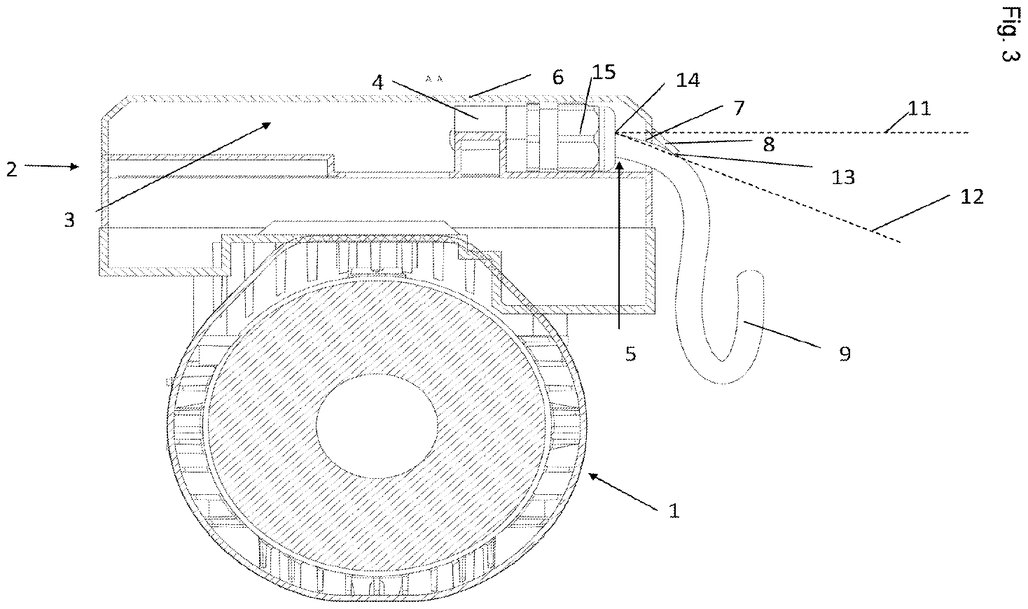

FIG. 3 shows a sectional diagram of the electric motor 1 with the drive module 2. The drive module 2 is placed on the cooling fins of the electric motor 1. In the interior of the drive module 2, the electronics chamber with the adjacent connection chamber 3 is situated, which have a frequency converter and a speed regulator as well as the wiring thereof. In one variant of the disclosure, further control and regulation modules are integrated in the connection chamber 3. An element 4 separates the connection chamber 3 sealingly from the cable connection assembly 5.

The current-carrying cable 9 is fed to the cable connection assembly 5 via an opening 7 in the cover 6. The guide element 8 of the cover 6 orients a connection portion of a cable 9 of the cable connection assembly 5 downward and thus effectively prevents the ingress of moisture into the drive module 2. The guide element 8 orients the cable 9 downward at an angle between a horizontal 11 of the cable feed and a straight line 12 that extends between a contact point 13 of the guide element 8 on the cable 9 and a highest point 14 of the cable 9 directly at the exit point from a fixing element 15, of more than 5°, preferably more than 10°, in particular more than 15°, and/or less than 80°, preferably less than 70°, in particular less than 60°. In this exemplary embodiment, the fixing element 15 is in the form of a screwed cable gland.

The guide element 8 is preferably designed to yield elastically upward to compensate for an application of force. The cover 6 seals the drive module 2 with sealing elements (not shown), so that the drive module and in particular the connection chamber 3 and/or the electronics chamber is protected from penetrating moisture.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-9. (canceled)

10. An electric motor comprising:
a drive module, which has a connection chamber and a cable connection assembly, wherein the connection chamber is closed with a cover, and the cover projects beyond the cable connection assembly.

11. The electric motor as claimed in claim 10, wherein the connection chamber is spatially separated from the cable connection assembly by an element.

12. The electric motor as claimed in claim 11, wherein the cover spatially encloses the cable connection assembly.

13. The electric motor as claimed in claim 12, wherein the cover has at least one opening.

14. The electric motor as claimed in claim 13, wherein the cover is formed as a single piece.

15. The electric motor as claimed in claim 14, wherein the drive module has a guide element that orients a connection portion of a cable of the cable connection assembly downward.

16. The electric motor as claimed in claim 15, wherein the guide element orients the cable downward at an angle between a horizontal of the cable feed and a straight line between a contact point of the guide element on the cable and a highest point of the cable directly at the exit point from a fixing element, of more than 5°, and/or less than 80°.

17. The electric motor as claimed in claim 16, wherein the guide element is configured to yield elastically upward to compensate for an application of force.

18. The electric motor as claimed in claim 17, wherein the cover has at least one seal element.
